(19) United States
(12) Patent Application Publication
(10) Pub. No.: US 2015/0324771 A1
(43) Pub. Date: Nov. 12, 2015

(54) SYSTEMS AND METHODS FOR PROVIDING AN OPTIMIZED PAYMENT LOCATION FOR CASH PAYMENTS

(71) Applicant: Stephen Capps, San Carlos, CA (US)

(72) Inventor: Stephen Capps, San Carlos, CA (US)

(73) Assignee: PayNearMe, Inc., Sunnyvale, CA (US)

(21) Appl. No.: 14/274,969

(22) Filed: May 12, 2014

(51) Int. Cl. G06Q 20/10

(52) U.S. Cl. CPC G06Q 20/102

(57) ABSTRACT

Disclosed herein are systems and methods to facilitate fast and safe cash payments including systems and methods for generating an optimized payment location for a customer by: storing geolocation information for a plurality of points-of-service; receiving customer information including geolocation information for the customer of the bill provider from the bill provider; determining an optimized payment location for the customer by comparing the stored point-of-service geolocation information to the customer geolocation information; generating a token that is a reference to the customer information; and transmitting with the service provider system the optimized payment location and the token to the bill provider.

### SUMMARY

The present invention relates to systems and methods to facilitate fast and safe cash payments that overcome many of the difficulties of the current systems. Specifically, presented herein are systems and methods in which a service provider system generates an optimized payment location for a customer by: storing geolocation information for a plurality of points-of-service; receiving customer information including geolocation information for the customer of the bill provider from the bill provider; determining an optimized payment location for the customer by comparing the stored point-of-service geolocation information to the customer geolocation information; generating a token that is a reference to the customer information; and transmitting with the service provider system the optimized payment location and the token to the bill provider.

### BRIEF DESCRIPTION OF THE FIGURES

Together with this written description, the figures further serve to explain the principles of, and to enable a person skilled in the relevant art, to make and use the claimed systems and methods.

FIG. 1 is a high-level flow process chart illustrating the relationships between the parties involved in the presented systems and methods.

FIG. 2 is a map showing exemplary point-of-service locations in an area of Los Angeles.

FIG. 3 is an exemplary bill incorporating a token that may be generated and/or used in conjunction with the present invention.

FIG. 4 is a high-level process chart illustrating one aspect of the present invention.

FIG. 5 is a high-level process chart illustrating one aspect of the present invention.

FIG. 6 is a high-level process chart illustrating one aspect of the present invention.

FIG. 7 is a schematic drawing of an exemplary service provider system used to implement the methods presented herein.

### DETAILED DESCRIPTION

Advancements in technology are increasingly changing the way consumers pay for goods and services, including the way customers pay their bills. For bill payments, many customers are turning to electronic payments instead of cash. Moreover, many bill providers such as utilities encourage their customers to use electronic payments to improve security and reduce paperwork. Several forms of electronic payment have been developed and are in use. For example, many customers use credit cards or electronic checks (e.g., e-checks) to pay bills. In the case of a credit card payment, the purchaser typically provides a credit card number and security code associated with an account to be charged. In the case of payment via an electronic check, a purchaser typically provides an American Bankers Association (ABA) routing number, and account number associated with an account to be charged. These methods of electronic payment are typically backed by a financial institution, such as a bank, that pays the retailer and extends credit to the purchaser or debits a monetary amount from the purchaser's account. Thus, the billing company secures payment from the financial institution prior to providing an item, and the purchaser is obligated to reimburse the financial institution. Alternatively, many customers pay bills using personal checks or with on-line bill payment services. These services are also typically provided by a financial institution such as a bank.

Electronic payments, checks, and on-line bill payments are often provided without any face-to-face interaction between the retailer and the customer. And although electronic payments, checks, and on-line bill payments may be available to some customers, other customers may not have access to these forms of payment. For example, individuals with no credit-cards or bank accounts may not be able to provide these forms of payment. Further, some people may not trust the available forms of electronic payments, checks, or on-line bill payments for fear of fraud, identity theft, or the like. A customer who does not have access to, or does not trust the traditional forms of bill payment, may rely on other forms of payment, such as mailing in cash or a money order or traveling to the nearest office for the billing company.

But many billing companies discourage cash payments. And traveling to the nearest office of the billing company is often impractical or very difficult and time-consuming. In addition to causing problems for bill payers, these issues may discourage prompt and full payment of bills by customers who would otherwise have paid if given a more-convenient payment method. And the delay caused by mailing a payment or traveling to an office of a billing company can cause late payments with accompanying accounting problems for the billing company and late charges for the customer.

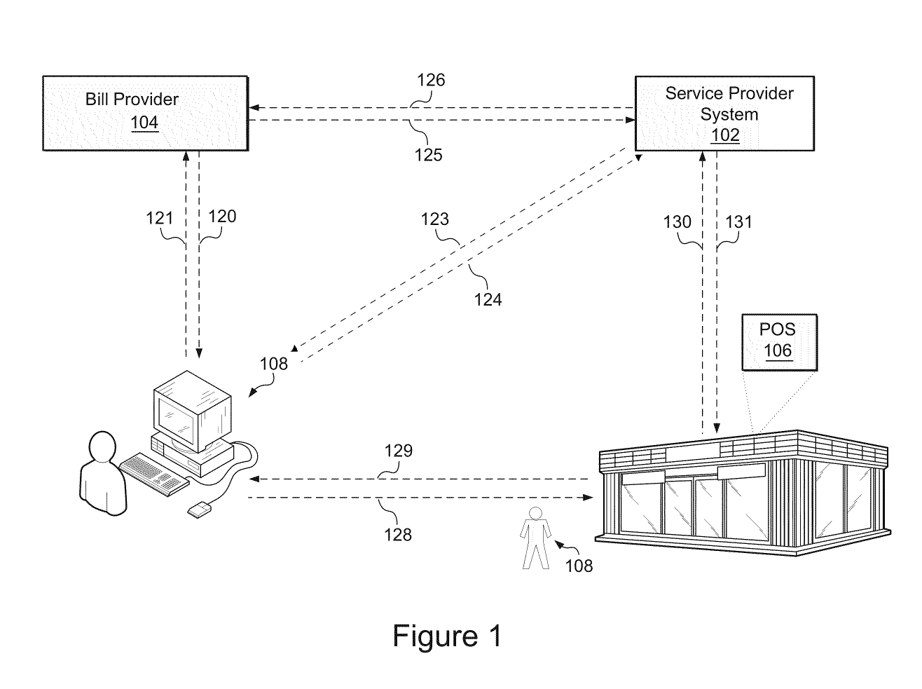

The present invention relates to systems and methods to facilitate fast and safe cash payments that overcome many of the difficulties of the current systems. Specifically, the present invention provides systems and methods for generating an optimized payment location for a customer of a billing company, or bill provider. The optimized payment location may provide a customer with a more-convenient, closer, and/or safer payment location. The following is a description of one or more embodiments of the present invention, with reference to FIGS. 1-7. The present invention is not limited to the particular embodiments described, and the terminology used herein is for the purpose of describing particular embodiments only.

FIG. 1 is a high-level flow illustration, showing exemplary relationships between the parties involved in the presented systems and methods. In this example, four parties are involved: (1) a service provider having a service provider system 102; (2) a bill provider 104; (3) a point-of-service (“POS”) 106; and (4) a customer 108. The dashed lines in FIG. 1 generally represent a flow of information, data, or process or interaction between respective parties. In practice, the dashed lines in FIG. 1 may represent user interfaces and/or application program interfaces (APIs) for the transmission of information, data, instructions, funds, etc. The flow of information, data, or process between the respective parties may be direct or may flow through systems or parties not shown in FIG. 1.

In a scenario consistent with FIG. 1, a customer 108 wants to make a cash payment for a bill the customer received from a bill provider 104. Making a cash payment to the bill provider 104 may be logistically difficult because the bill provider 104 is remote from the customer 108 or because the bill provider 104 does not accept cash payments. The service provider system 102 exchanges information with the customer 108 and/or the bill provider 104. These exchanges are represented by lines 120-121 and 123-126. Based on these exchanges, the service provider system 102 provides a token to the customer 108 directly or indirectly (e.g., through the bill provider 104). The customer 108 presents the token and a payment at the point-of-service 106. This is shown as line 128. The point-of-service 106 communicates with the service provider system 102 to notify the service provider system 102 of the presentment of the token and payment and to transmit funds to the service provider system 102. The interaction between the point-of-service 106 and the service provider system 102 are shown as lines 130 and 131. The point-of-service 106 may interact with the customer 108 including by providing information, merchandise, or a token to the customer 108. This interaction is shown as line 129.

In one embodiment, to generate an optimized payment location for a customer 108, the service provider system 102 stores geolocation information for a plurality of points-of-service 106. The points-of-service 106 may include establishments local to the customer 108 that are equipped to accept cash payments. The points-of-service 106 presented to the customer 108 may include specific locations (e.g., individual stores) and may include general store information (e.g., a retail chain name). The points-of-service 106 may include retail establishments such as convenience stores, grocery stores, gas stations, and department stores. The points-of-service 106 may also include automated equipment such as automatic teller machines (“ATMs”). The presentation of the points-of-service 106 to the customer 108 may be based on the customer's information. For example, if the customer's information includes an address, the service provider system may 102 may present an address for a point-of-service 106 close to the customer's address. The geolocation information may include latitude and longitude, address information, coordinates, and the like.

Next the service provider system 102 receives customer information including geolocation information for the customer of the bill provider 104 from the bill provider. As with the geolocation information stored in the service provider system 102, this geolocation information may include latitude and longitude, address information, coordinates, and the like. The customer geolocation information could be the customer's home or business address or a preferred payment location. The service provider system 102 then determines an optimized payment location for the customer by comparing the stored point-of-service geolocation information to the customer geolocation information. The optimized payment location is the location of one of the plurality of points-of-service 106 stored in the service provider system that the service provider system 102 determines should be presented to the customer.

The optimized payment location can be the point-of-service 106 that is closest to the customer geolocation information, for example the point-of-service 106 that is physically closest to the customer's billing address, work address, or current address. Alternatively, the optimized payment location could be a point-of-service 106 location that has the lowest travel time from the customer geolocation information. In another embodiment, the optimized payment location can be a point-of-service 106 in an area determined by the density of points-of-service within a certain location or radius.

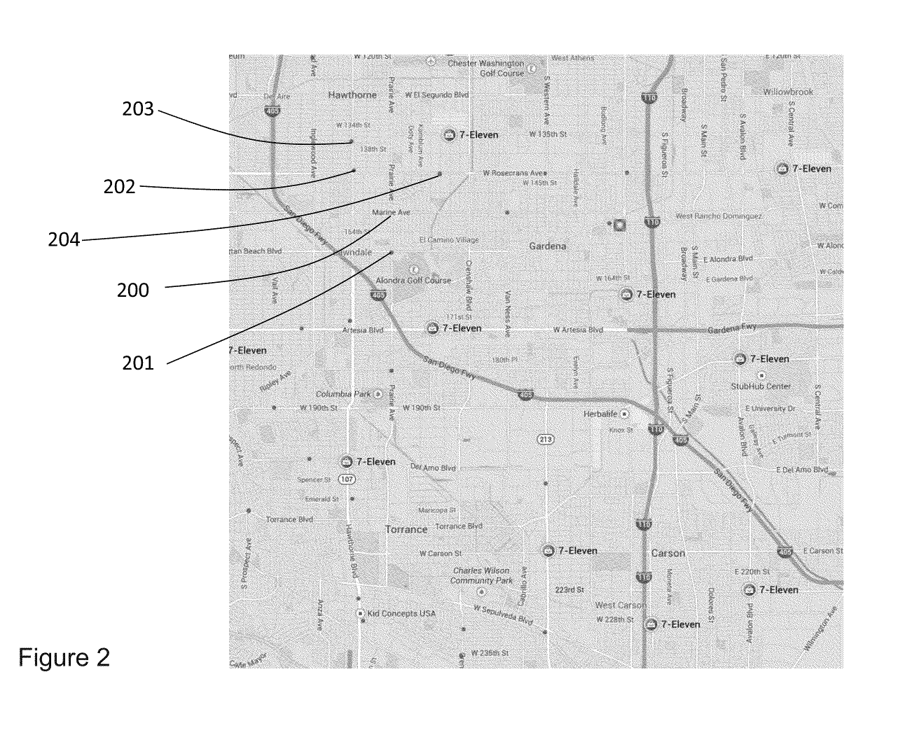

For example, FIG. 2 is a map of a section of the Los Angeles area showing points-of-service 106. Each of the points-of-service 106 is shown as a dot on the map including locations 201-204. In this example, the service provider system 102 uses the intersection of Prairie Avenue and Marine Avenue 200, which is a location from the customer geolocation information, to determine the optimized payment location. This location could be the customer's home address, work address, or current location for example. Points-of-service 201, 202, and 204 are all approximately equidistant from the intersection of Prairie Avenue and Marine Avenue 200. In one embodiment, one or more of these points is the optimized payment location. In another embodiment, the service provider system 102 determines that point-of-service 202 is an optimized payment location because it is in an area with a higher density of points-of-service because of its proximity to point-of-service 203. The service provider system 102 can calculate the point-of-service density at the time it receives the customer geolocation information or the service provider system 102 may pre-calculate the density. In one example, the service provider system 102 uses a grid and determines the density of points-of-service in each section of the grid.

The service provider system 102 may also use information about the business hours for the points-of-service to determine the optimized payment location. For example, the service provider system 102 may select a point-of-service that farther from the customer's geolocation information but is open twenty-four hours per day over a closer point-of-service that is only open during business hours. Similarly, the service provider system 102 may receive information from the bill provider 104 or the customer 108 regarding the times that the customer prefers to make bill payments. Based on that information, the service provider system 102 may select a point-of-service that is open during the times during which the customer prefers to make bill payments. The service provider system 102 may use other factors such as crime rates in certain areas and traffic patterns as well as any weighted combination of the factors discussed to determine the optimized payment location.

After the service provider system 102 determines the optimized payment location, it generates a token that is a reference to the customer information. The token is formatted for use at the point-of-service determined to be the optimized payment location. The token could be an optical machine-readable representation of data like a linear barcode or geometric or two-dimensional barcode. Also, the token could be a number generated by the service provider system 102 that provides a reference to the customer information. For example, the token could include could a barcode, payment code, customer number, or the like. The token provides sufficient information to correlate a payment made in association with the token to the customer 108 that made the payment or for whom the payment was made.

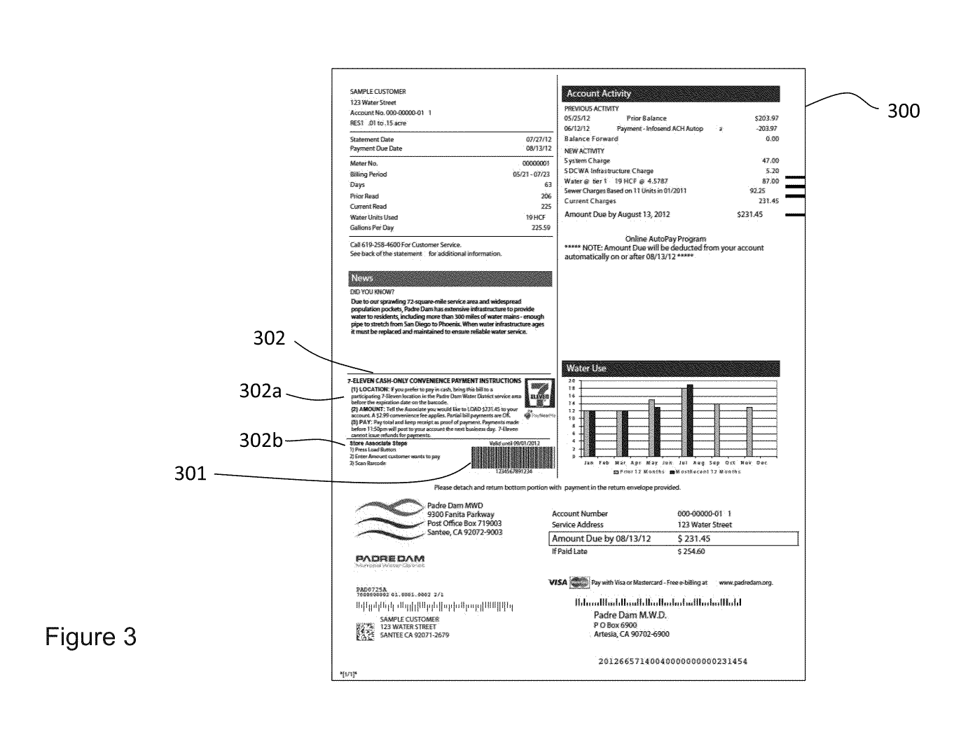

The service provider system 102 then transmits the optimized payment location and the token to the bill provider 104. The bill provider 104 provides the token and optimized payment location to the customer in a printed bill or a digital bill for example. FIG. 3 is an example of a printed bill 300 that the bill provider 104 may provide to the customer 108. On the printed bill 300, there is a barcode 301. The barcode 301 is an example of a token used in this invention. As shown in FIG. 3, the bill may also contain payment instructions 302. The payment instructions 302 may include instructions 302a for the customer and instructions 302b for the associate or clerk at the point-of-service 106. The payment instructions 302 are very important as the payment procedure may vary between different points-of-service. To ensure an efficient experience for both the customer and the clerk at the point-of-service, the instructions 302 may be selected for the specific point-of-service or type of point-of-service selected as the optimized payment location.

In one embodiment, the service provider system 102 selects the payment instructions 302 to be printed on the bill 300 based on the type, location, or other criteria of the point-of-service 106 that the service provider system 102 determined to be the optimized payment location. In this example, the payment instructions 302 are specific to the point-of-service determined to be the optimized payment location. The service provider system 102 then transmits the payment instructions 302 to the bill provider.

The payment instructions that the service provider system 102 transmits to the bill provider 104 may include logos, maps, addresses, directions, hours of operation, instructions for the customer on how to make a payment at the point-of-service, as well as instructions for the clerk at the point-of-service 106 on how to process the payment. The service provider system 102 may transmit the token and payment information to the bill provider 104 as simple data that the bill provider 104 formats and prints on the bill 300. The service provider system 102 may transmit the token and payment instructions to the bill provider 104 as an image file or multiple image files that contain a part or all of the token information 301 and payment information 302 printed on the bill 300.

The customer 108 may receive the token, for example, by mail, on a computer or mobile device. When the customer 108 wants to make a payment to the bill provider 104, the customer 108 takes the token to point-of-service 106 and makes a payment. After the customer 108 presents the token at the point-of-service 106, the point-of-service sends a confirmation that the customer presented the token and a payment having a payment amount at the point-of-service. The payment amount is the amount that the customer 108 presented to the point-of-sale 106 with the token. The service provider system 102 receives the confirmation that the customer 108 presented the token and payment to the point-of-service 106. The service provider system 102 may send information to the point-of-service 106 in response to the information sent from the point-of-service 106, including an authorization to accept payment from the customer 108.

The service provider system 102 also receives a portion of the payment amount received at the point-of-service 104 from the customer 108. The amount received by the service provider system 102 may depend on the agreements between the service provider, the bill provider, and the point-of-service. For example, the amount received by the service provider system 102 may be less than the amount the customer 108 presented to the point-of-service 106 if, for example, the point-of-service 106 retains some of the payment. Alternatively, the amount received by the service provider system 102 may be more than the amount the customer 108 presented to the point-of-service 106 if, for example, the point-of-service 106 pays the service provider to increase traffic to the point-of-service.

The service provider, the bill provider, and the point-of-service may use a convenience fee model in which a fee is typically visible to the customer. In a convenience fee model, the customer generally pays any extra costs for the convenience of conducting the transaction. The parties may also use a fixed or variable commission model in which the fee is typically not shown to the customer. In a fixed or variable commission model, costs are typically incurred by the bill provider 104. Variable commission can be established between one or more parties, and dependent on one or more factors. For example, a variable commission structure may call for percentages being paid by/to the bill provider 104 and/or the point-of-service 106.

The service provider system 102 also transmits a portion of the payment amount received and a portion of the customer information to the bill provider 104. The bill provider 104 uses the customer information that the service provider system 102 transmits to correlate the payment it receives with the customer 108. The amount received by the bill provider 104 may depend on the agreements between the service provider, the bill provider, and the point-of-service.

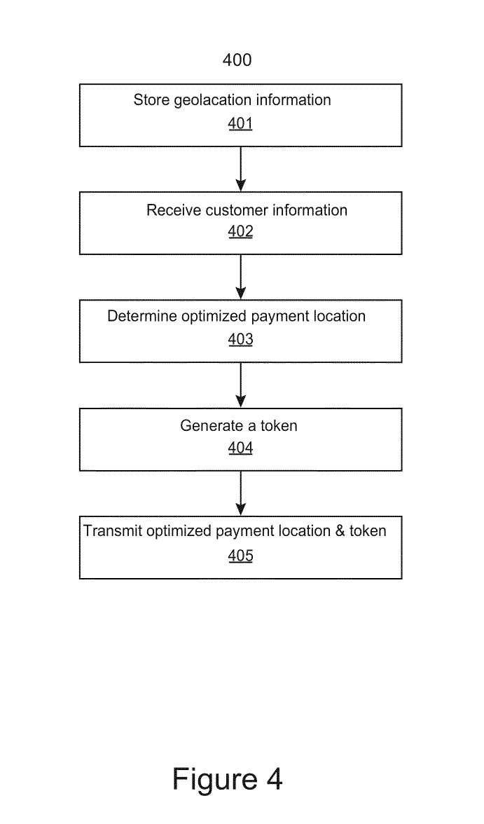

FIG. 4 is a high-level flowchart illustrating a method 400 for facilitating bill payments with cash as described above. The method includes the service provider system 102: 401 storing geolocation information for a plurality of points-of-service; 402 receiving customer information including geolocation information for the customer of the bill provider from the bill provider; 403 determining an optimized payment location for the customer by comparing the stored point-of-service geolocation information to the customer geolocation information, wherein the optimized payment location is the location of one of the plurality of points-of-service stored in the service provider system; 404 generating a token that is a reference to the customer information, wherein the token is formatted for use at the point-of-service determined to be the optimized payment location; and 405 transmitting the optimized payment location and the token to the bill provider.

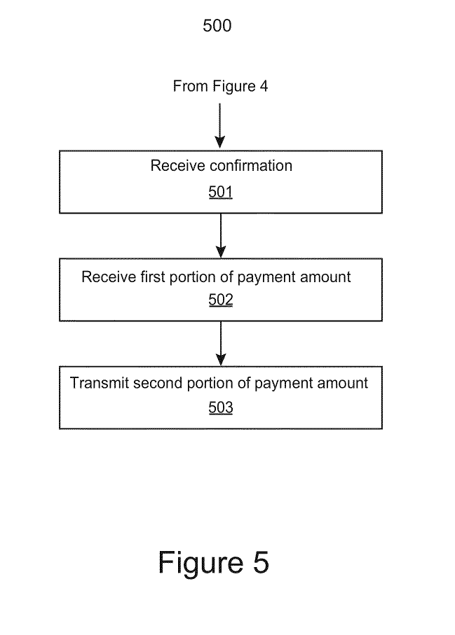

FIG. 5 is another high-level flowchart illustrating a method 500 for facilitating bill payments with cash as described above. In addition to the steps shown in FIG. 4, method includes the service provider system 102: 501 receiving a confirmation that the customer presented the token and a payment having a payment amount at one of the plurality of points-of-service; 502 receiving a first portion of the payment amount received at the point-of-service; and 503 transmitting a second portion of the payment amount received at the point-of-service and a portion of the customer information to the bill provider.

In another embodiment the service provider system 102 determines the optimized payment location based on the location or locations at which the customer 108 has made a payment or payments in the past. In this embodiment, the service provider system 102 receives a confirmation that the customer 108 has presented the token at a point-of-service 106. In addition to reconceiving confirmation that the customer presented the token and a payment at a point-of-service 106, and receiving and transmitting portions of the payment amount, the service provider system also receives geolocation information for the point-of-service at which the customer presented the token. The service provider system 102 then determines a second optimized payment location for the customer by comparing the stored point-of-service geolocation information to the customer geolocation information and to the geolocation information for the point-of-service at which the customer presented the token. Based on this information, the service provider system 102 generates a second token that is also a reference to the customer information and is formatted for use at the point-of-service determined to be the second optimized payment location. The service provider system 102 then transmits the second optimized payment location and the second token to the bill provider.

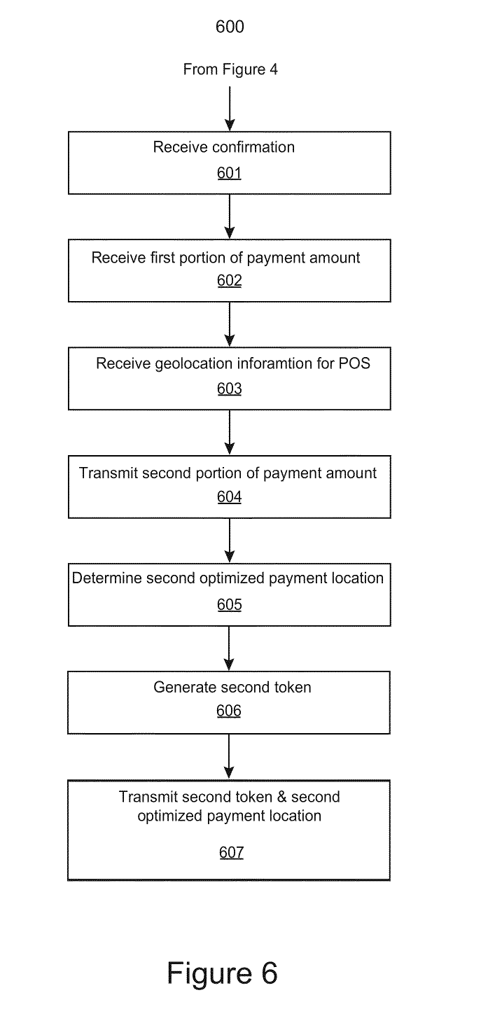

FIG. 6 is a further high-level flowchart illustrating a method 600 for facilitating bill payments with cash as described above. In addition to the steps shown in FIG. 4, method includes the service provider system 102: 601 receiving a confirmation that the customer presented the token and a payment having a payment amount at one of the plurality of points-of-service; 602 receiving a first portion of the payment amount received at the point-of-service; 603 receiving geolocation information for the point-of-service at which the customer presented the token; 604 transmitting a second portion of the payment amount received at the point-of-service and a portion of the customer information to the bill provider; 605 determining a second optimized payment location for the customer by comparing the stored point-of-service geolocation information to the customer geolocation information and to the geolocation information for the point-of-service at which the customer presented the token, wherein the second optimized payment location is the location of one of the plurality of points-of-service stored in the service provider system; 606 generating a second token that is a reference to the customer information, wherein the second token is formatted for use at the point-of-service determined to be the second optimized payment location; and 607 transmitting with the service provider system the second optimized payment location and the second token to the bill provider.

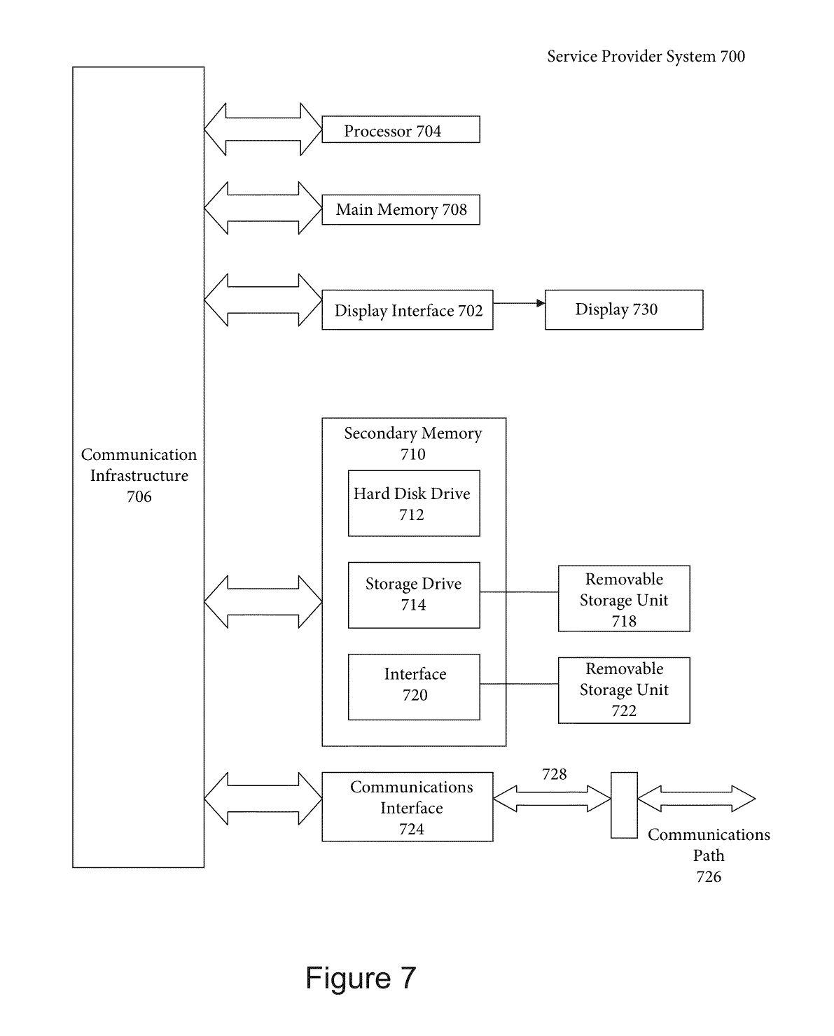

The service provider system 102 may comprise one or more computer systems capable of carrying out the functionality described herein. For example, FIG. 7 is a schematic drawing of a service provider system 700 used to implement the methods presented herein. Service provider system 700 includes one or more processors, such as processor 704. The processor 704 is connected to a communication infrastructure 706 (e.g., a communications bus, cross-over bar, or network). Computer system 700 can include a display interface 702 that forwards graphics, text, and other data from the communication infrastructure 706 (or from a frame buffer not shown) for display on a local or remote display unit 730.

Service provider system 700 also includes a main memory 708, such as random access memory (RAM), and may also include a secondary memory 710. The secondary memory 710 may include, for example, a hard disk drive 712 and/or a removable storage drive 714, representing a floppy disk drive, a magnetic tape drive, an optical disk drive, flash memory device, etc. The removable storage drive 714 reads from and/or writes to a removable storage unit 718. Removable storage unit 718 represents a floppy disk, magnetic tape, optical disk, flash memory device, etc., which is read by and written to by removable storage drive 714. The removable storage unit 718 includes a computer usable storage medium having stored therein computer software, instructions, and/or data.

In alternative embodiments, secondary memory 710 may include other similar devices for allowing computer programs or other instructions to be loaded into a service provider system 700. Such devices may include, for example, a removable storage unit 722 and an interface 720. Examples of such may include a program cartridge and cartridge interface (such as that found in video bill devices), a removable memory chip (such as an erasable programmable read only memory (EPROM), or programmable read only memory (PROM)) and associated socket, and other removable storage units 722 and interfaces 720, which allow computer software, instructions, and/or data to be transferred from the removable storage unit 722 to a service provider system 700.

Service provider system 700 may also include a communications interface 724. Communications interface 724 allows computer software, instructions, and/or data to be transferred between a service provider system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical, or other signals capable of being transmitted or received by communications interface 724. These signals 728 are provided to and from the communications interface 724 via a communications path (e.g., channel) 726. This channel 726 carries signals 728 and may be implemented using wire or cable, fiber optics, a telephone line, a cellular link, a radio frequency (RF) link, a wireless communication link, and other communications channels.

Computer programs (also referred to as computer control logic) are stored in main memory 708 and/or secondary memory 710. Computer programs may also be received via communications interface 724. Such computer programs, when executed, enable the service provider system 700 to perform the features of the present invention, as discussed herein. In particular, the computer programs, when executed, enable the processor 704 to perform the features of the presented methods. Accordingly, such computer programs represent controllers of the service provider system 700. Where appropriate, the processor 704, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into a service provider system 700 using removable storage drive 714, interface 720, hard drive 712, or communications interface 724. The control logic (software), when executed by the processor 704, causes the processor 704 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

The figures included herein serve as embodiments of the presented systems and methods. Each individual process or sub-process performed within the embodiments described can be performed by one or more parties, as well as one or more computer systems. For example, in one embodiment, some or all of the communications and data transfers between bill provider, service provider system, and point-of-service are performed via an automated computer-based system, such as an application program interface. As such, the embodiments presented in the figures are not intended to be limiting.

What is claimed is:

1. A method for generating an optimized payment location for a customer of a bill provider comprising the steps of:
storing with a service provider system geolocation information for a plurality of points-of-service;
receiving with the service provider system customer information including geolocation information for the customer of the bill provider from the bill provider;
determining with the service provider system an optimized payment location for the customer by comparing the stored point-of-service geolocation information to the customer geolocation information, wherein the optimized payment location is the location of one of the plurality of points-of-service stored in the service provider system;
generating with the service provider system a token that is a reference to the customer information, wherein the token is formatted for use at the point-of-service determined to be the optimized payment location; and
transmitting with the service provider system the optimized payment location and the token to the bill provider.

2. The method of claim 1 further comprising:
receiving with the service provider system a confirmation that the customer presented the token and a payment having a payment amount at one of the plurality of points-of-service;
receiving with the service provider system a first portion of the payment amount received at the point-of-service; and
transmitting with the service provider system a second portion of the payment amount received at the point-of-service and a portion of the customer information to the bill provider.

3. The method of claim 1 further comprising:
receiving with the service provider system a confirmation that the customer presented the token and a payment having a payment amount at one of the plurality of points-of-service;
receiving with the service provider system a first portion of the payment amount received at the point-of-service;
receiving with the service provider system geolocation information for the point-of-service at which the customer presented the token;
transmitting with the service provider system a second portion of the payment amount received at the point-of-service and a portion of the customer information to the bill provider;
determining with the service provider system a second optimized payment location for the customer by comparing the stored point-of-service geolocation information to the customer geolocation information and to the geolocation information for the point-of-service at which the customer presented the token, wherein the second optimized payment location is the location of one of the plurality of points-of-service stored in the service provider system;
generating with the service provider system a second token that is a reference to the customer information, wherein the second token is formatted for use at the point-of-service determined to be the second optimized payment location; and
transmitting with the service provider system the second optimized payment location and the second token to the bill provider.

4. The method of claim 1 further comprising:
selecting with the service provider system payment instructions specific to the point-of-service determined to be the optimized payment location; and
transmitting with the service provider system the payment instructions to the bill provider.

5. The method of claim 1 wherein the customer geolocation information comprises a home address for the customer.

6. The method of claim 1 wherein the customer geolocation information comprises a work address for the customer.

7. The method of claim 1 wherein the customer geolocation information comprises a current location for the customer.

8. The method of claim 4 wherein the payment instructions comprise instructions for the clerk at the point-of-service determined to be the optimized payment location.

9. The method of claim 4 wherein the payment instructions comprise instructions for the customer.

10. The method of claim 4 comprising transmitting with the service provider system the payment instructions and the token as an image file.

11. The method of claim 1, wherein the step of determining an optimized payment location comprises determining with the payment provider system the location of the closest one of the plurality of points-of-service that is physically closest to a location specified by the customer geolocation information, and wherein the optimized payment location is the location of the closest one of the plurality of points-of-service.

12. The method of claim 1, wherein the step of determining an optimized payment location comprises determining with the payment provider system the highest density area of points-of-service within a distance from a location specified by the customer geolocation information, and wherein the optimized payment location is the location of one of the points-of-service within the highest density area.

13. The method of claim 1, wherein the step of determining an optimized payment location comprises determining with the payment provider system a weighted combination of: (i) the proximity of one or more of the points-of-service to a location specified by the customer geolocation information, (ii) the highest density area of points-of-service within a distance from the location specified by the customer geolocation information, and (iii) the operating hours of the points-of-service within a second distance from the location specified by the customer geolocation information.

14. A method for generating an optimized payment location for a customer comprising the steps of:
storing with a service provider system geolocation information for a plurality of points-of-service;
receiving with the service provider system customer information including geolocation information for the customer;
determining with the service provider system an optimized payment location for the customer by comparing the stored point-of-service geolocation information to the customer geolocation information, wherein the optimized payment location is the location of one of the plurality of points-of-service stored in the service provider system;
generating with the service provider system a token that is a reference to the customer information, wherein the token is formatted for use at the point-of-service determined to be the optimized payment location;
transmitting with the service provider system the optimized payment location and the token to the customer.

15. The method of claim 14 further comprising:
selecting with the service provider system payment instructions specific to the point-of-service determined to be the optimized payment location; and
transmitting with the service provider system the payment instructions to the bill provider.

16. The method of claim 15 wherein the payment instructions comprise instructions for the clerk at the point-of-service determined to be the optimized payment location.

17. The method of claim 15 wherein the payment instructions comprise instructions for the customer.

18. The method of claim 14 wherein the step of determining an optimized payment location comprises determining with the payment provider system the location of the closest one of the plurality of points-of-service that is physically closest to a location specified by the customer geolocation information, and wherein the optimized payment location is the location of the closest one of the plurality of points-of-service.

19. The method of claim 14 wherein the step of determining an optimized payment location comprises determining with the payment provider system the highest density area of points-of-service within a distance from a location specified by the customer geolocation information, and wherein the optimized payment location is the location of one of the points-of-service within the highest density area.

20. The method of claim 14 wherein the step of determining an optimized payment location comprises determining with the payment provider system a weighted combination of: (i) the proximity of one or more of the points-of-service to a location specified by the customer geolocation information, (ii) the highest density area of points-of-service within a distance from the location specified by the customer geolocation information, and (iii) the operating hours of the points-of-service within a second distance from the location specified by the customer geolocation information.
